(19) United States
(12) Patent Application Publication
(10) Pub. No.: US 2008/0126643 A1
(43) Pub. Date: May 29, 2008

(54) SEMICONDUCTOR CIRCUIT

(75) Inventor: Ryohei HIGUCHI, Tokyo (JP)

Correspondence Address: BUCHANAN, INGERSOLL & ROONEY PC, POST OFFICE BOX 1404, ALEXANDRIA, VA, 22313-1404, US

(73) Assignee: RENESAS TECHNOLOGY CORP., Tokyo (JP)

(21) Appl. No.: 11/940,751

(22) Filed: Nov. 15, 2007

(30) Foreign Application Priority Data
Nov. 27, 2006 (JP) 2006-317996

(51) Int. Cl. G06F 13/364

(52) U.S. Cl. 710/113

(57) ABSTRACT

The invention provides a technique capable of allowing a CPU to execute interruption processing early. One of plural bus masters is a CPU. Each of the bus masters accesses a bus slave via a common bus. A bus access arbitration circuit arbitrates bus access requests among the bus masters. An interruption controller accepts an interruption request, and then notifies the CPU to execute interruption processing and outputs, to the bus access arbitration circuit, a preferential processing request signal for requesting preferential acceptance of the bus access request from the CPU. The bus access arbitration circuit receives the preferential processing request signal, and then accepts the bus access request from the CPU preferentially rather than the bus access requests from the bus masters other than the CPU.

### BACKGROUND OF THE INVENTION

1. Field of the Invention

The present invention relates to a semiconductor circuit including plural bus masters one of which is a CPU (Central Processing Unit).

2. Description of the Background Art

As described in ARM, “AMBA® Specification (Rev 2.0)”, 1999, conventionally, a semiconductor circuit such as system LSI (Large Scale Integration) has a configuration that a CPU and other bus masters are connected to a memory and other bus slaves via a common bus. The bus master accesses the bus slave via the bus to exchange data with the bus slave. In such a semiconductor circuit, if there occurs a conflict among bus access requests from the plural bus masters, a bus access arbitration circuit arbitrates the bus access requests among the plural bus masters. More specifically, the bus access arbitration circuit accepts the bus access requests from the plural bus masters, and then gives a bus usage right to the bus master which has issued the bus access request having a highest priority. This authorized bus master can access the bus slave.

Examples of a method for arbitrating among plural bus masters in a request to access a bus include a method of performing arbitration on the basis of fixed priorities which have been preset, an LRU (Least Recently Used) method of giving a bus access right to a bus master which does not acquire the bus access right over a longest period of time, and the like. It is to be noted that techniques concerning a semiconductor circuit including a CPU are disclosed in Japanese Patent Application Laid-Open Nos. 2004-038265, 2003-256353, 2002-259323, 2000-122963, and 11-143823 (1999).

However, the foregoing conventional semiconductor circuit has the following disadvantages. That is, if the bus access request issued by the CPU has a low priority and the bus masters other than the CPU also issue the bus access requests, the CPU can not acquire the bus usage right early, thereby failing to execute interruption processing. As a result, the CPU can not access the bus slave promptly in some cases.

On the other hand, if the CPU executes the interruption processing at the time when the bus accesses from the bus masters other than the CPU are concentrated, the bus masters other than the CPU are hindered from accessing the bus in some cases.

### SUMMARY OF THE INVENTION

A first object of the present invention is to provide a technique capable of allowing a CPU to execute interruption processing early. A second object of the present invention is to provide a technique capable of eliminating a disadvantage that the interruption processing of the CPU hinders bus masters other than the CPU from accessing a bus.

A first semiconductor circuit according to the present invention includes plural bus masters, a bus access arbitration circuit, and an interruption controller. One of the plural bus masters is a CPU capable of executing interruption processing. The bus access arbitration circuit arbitrates bus access requests among the plural bus masters. The interruption controller notifies the CPU to execute the interruption processing. The interruption controller accepts an interruption request, and then notifies the CPU to execute the interruption processing and outputs, to the bus access arbitration circuit, a preferential processing request signal for requesting preferential acceptance of the bus access request from the CPU. The bus access arbitration circuit receives the preferential processing request signal, and then accepts the bus access request from the CPU preferentially rather than the bus access requests from the plural bus masters other than the CPU.

The interruption controller accepts the interruption request, and then accepts the bus access request from the CPU preferentially rather than the bus access requests from the remaining bus masters. Therefore, the CPU can execute the interruption processing early.

A second semiconductor circuit according to the present invention includes plural bus masters, a bus access arbitration circuit, plural interruption controllers, and a preferential request arbitration circuit. Some of the plural bus masters are CPUs. The bus access arbitration circuit arbitrates bus access requests among the plural bus masters. The plural interruption controllers are provided for the plural CPUs in one to one correspondence. Each interruption controller notifies the relevant CPU to execute interruption processing. Each of the plural interruption controllers accepts an interruption request from the relevant CPU, and then notifies the relevant CPU to execute the interruption processing and outputs, to the preferential request arbitration circuit, a preferential processing request signal for requesting preferential acceptance of the bus access request from the relevant CPU. The preferential request arbitration circuit receives plural preferential processing request signals simultaneously, and then determines a CPU, which has the bus access request to be accepted preferentially, of the plural CPUs corresponding to the interruption controllers which have outputted the preferential processing request signals. The bus access arbitration circuit accepts the bus access request from the CPU, which is determined by the preferential request arbitration circuit, preferentially rather than the bus access requests from the plural bus masters other than the determined CPU.

The preferential request arbitration circuit determines the CPU, which has the bus access request to be accepted preferentially, of the plural CPUs included in the bus masters, and then accepts the bus access request from the determined CPU preferentially rather than the bus access requests from the bus masters other than the determined CPU. Therefore, the determined CPU can execute the interruption processing early.

A third semiconductor circuit according to the present invention includes plural bus masters, a bus access arbitration circuit, and an interruption controller. One of the plural bus masters is a CPU capable of executing interruption processing. The bus access arbitration circuit arbitrates bus access request among the plural bus masters. The interruption controller accepts an interruption request, and then notifies the CPU to execute the interruption processing. The bus access arbitration circuit determines whether bus accesses from the plural bus masters other than the CPU are concentrated, and then outputs a busy signal to the interruption controller during a period that the bus accesses are concentrated. The interruption controller does not notify the CPU to execute the interruption processing during reception of the busy signal.

The interruption controller does not notify the CPU to execute the interruption processing during the reception of the busy signal. Therefore, if the bus accesses from the bus masters other than the CPU are concentrated, the CPU does not issue the bus access request based on the interruption processing. Accordingly, the bus masters other than the CPU can access the bus without being hindered by the interruption processing of the CPU.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a block diagram showing a configuration of a semiconductor circuit according to a first embodiment of the present invention;

FIG. 2 shows a configuration of an interruption controller according to a second embodiment of the present invention;

FIG. 3 shows a configuration of an interruption controller according to a third embodiment of the present invention;

FIG. 4 shows one example of priorities assigned to interruption request signals;

FIG. 5 is a block diagram showing a configuration of a semiconductor circuit according to a fourth embodiment of the present invention;

FIG. 6 is a block diagram showing a configuration of a semiconductor circuit according to a fifth embodiment of the present invention;

FIG. 7 shows a configuration of an interruption controller according to a sixth embodiment of the present invention; and

FIG. 8 shows a configuration of an interruption controller according to a seventh embodiment of the present invention.

### DESCRIPTION OF THE PREFERRED EMBODIMENTS

### First Embodiment

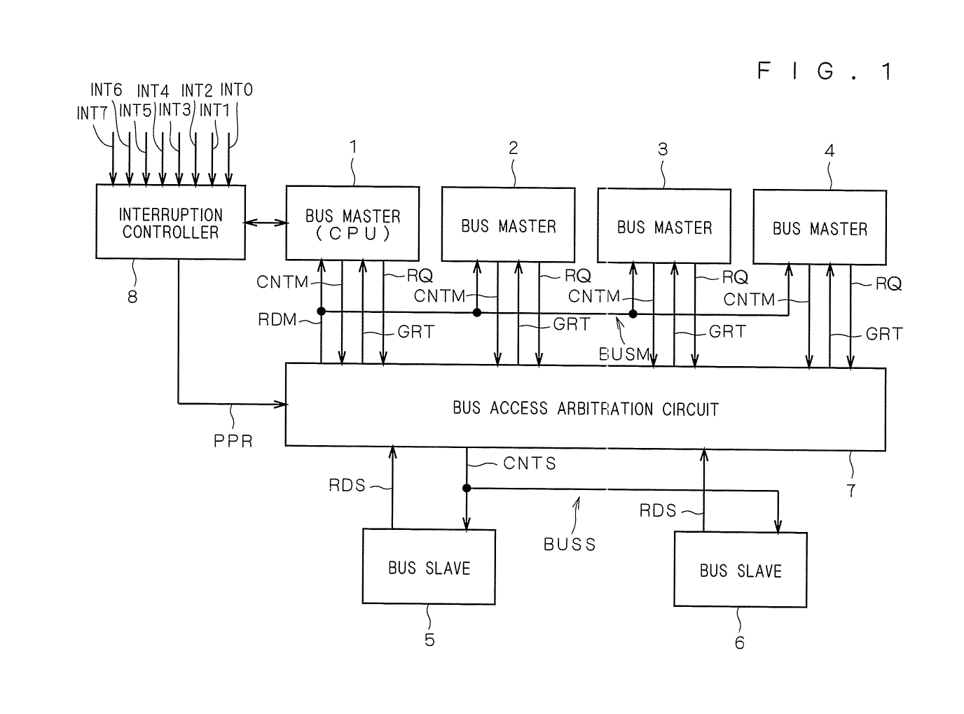

FIG. 1 is a block diagram showing a configuration of a semiconductor circuit according to a first embodiment of the present invention. As shown in FIG. 1, the semiconductor circuit according to the first embodiment includes plural bus slaves 5 and 6, plural bus masters 1 to 4 each of which accesses the bus slaves 5 and 6 via a common bus BUSS, and a bus access arbitration circuit 7 which arbitrates access requests to the bus BUSS among the plural bus masters 1 to 4.

Examples of the bus masters 1 to 4 include a CPU (Central Processing Unit), a DMA (Direct Memory Access) controller, and the like. In the first embodiment, one of the bus masters 1 to 4 is a CPU. Specifically, the bus master 1 is a CPU. Hereinafter, the bus master 1 is referred to as “the CPU 1” in some cases. Examples of the bus slaves 5 and 6 include a memory, a UART (Universal Asynchronous Receiver Transmitter), a DRAM (Dynamic Random Access Memory) controller, and the like.

The semiconductor circuit according to the first embodiment also includes an interruption controller 8 which accepts an interruption request to notify the CPU 1 to execute interruption processing in accordance with the interruption request. The interruption controller 8 receives plural interruption request signals INT0 to INT7 each indicating an interruption request. The interruption request signals INT0 to INT7 correspond to various kinds of interruption processing, and are outputted from the bus slaves 5 and 6 as well as other peripheral circuits (not shown). Herein, priorities are assigned to the interruption request signals INT0 to INT7, respectively. The interruption controller 8 receives some of the interruption request signals INT0 to INT7 simultaneously, and then selects the interruption request signal having the highest priority from among the received interruption request signals and notifies the CPU 1 to execute the interruption processing corresponding to the selected interruption request signal. The CPU 1 executes the interruption processing on the basis of the notification from the interruption controller 8. It is to be noted that, in a case of receiving only one of the interruption request signals INT0 to INT7, the interruption controller 8 selects the received interruption request signal.

Further, the interruption controller 8 according to the first embodiment receives at least one of the interruption request signals INT0 to INT7, and then outputs to the bus access arbitration circuit 7 a preferential processing request signal PPR for requesting preferential acceptance of the request to access the bus BUSS from the CPU 1 rather than the requests to access the bus BUSS from the remaining bus masters 2 to 4. The bus access arbitration circuit 7 receives the preferential processing request signal PPR, and then accepts the bus access request from the CPU 1 preferentially. After completion of the interruption processing, the CPU 1 notifies the interruption controller 8 of this completion, and the interruption controller 8 stops to output the preferential processing request signal PPR.

Next, detailed description will be given of operations of the semiconductor circuit according to the first embodiment. First, description will be given of operations of the semiconductor circuit in a case where the interruption controller 8 does not output the preferential processing request signal PPR. In order to access the bus slave 5 or 6, each of the bus masters 1 to 4 outputs, to the bus access arbitration circuit 7, an access request signal RQ indicating the request to access the bus BUSS. The bus access arbitration circuit 7 receives plural access request signals RQ simultaneously, and then selects one of the bus masters which have outputted the access request signals RQ. For example, in a case where priorities are assigned previously to the bus masters 1 to 4 or each of the bus masters 1 to 4 determines a priority to notify the bus access arbitration circuit 7 of this priority, the bus access arbitration circuit 7 selects a bus master having a highest priority. Alternatively, the bus access arbitration circuit 7 may select, from among the bus masters which have outputted the access request signals RQ, a bus master which does not acquire a bus access right over a longest period of time. Among the bus masters which have outputted the access request signals RQ, thereafter, the bus access arbitration circuit 7 outputs, to the selected bus master, a grant signal GRT indicating acceptance of the bus access request and outputs, to the remaining bus masters, a grant signal GRT indicating non-acceptance of the bus access request.

Each of the bus masters 1 to 4 outputs a control signal CNTM to the bus access arbitration circuit 7 when the bus access request thereof is accepted by the bus access arbitration circuit 7. The control signal CNTM contains a write data signal, an address signal, and a write signal for notification of a write operation in a case where the bus master 1, 2, 3 or 4 writes data to the bus slave 5 or 6. On the other hand, the control signal CNTM contains an address signal, and a read signal for notification of a read operation in a case where the bus master 1, 2, 3 or 4 reads data from the bus slave 5 or 6.

The bus access arbitration circuit 7 receives the control signal CNTM from the bus master which has the bus access request accepted by the bus access arbitration circuit 7. Then, the bus access arbitration circuit 7 outputs the control signal CNTM as a control signal CNTS to the bus slave 5 or 6 via the common bus BUSS. Herein, the bus access arbitration circuit 7 selects a bus slave to be accessed, from among the bus slaves 5 and 6, in accordance with the address signal contained in the received control signal CNTM. Thus, if the control signal CNTM contains a write signal, a write data signal contained in the control signal CNTM is written to the selected bus slave. On the other hand, if the control signal CNTM contains a read signal, data is read from the selected bus slave. The bus access arbitration circuit 7 receives read data RDS from the selected bus slave. Then, the bus access arbitration circuit 7 outputs the read data RDS as read data RDM to the bus master 1, 2, 3 or 4 via a common bus BUSM shared among the bus masters 1 to 4. Thus, the bus master having the bus access request accepted by the bus access arbitration circuit 7 can receive data from the bus slave.

The bus master having the bus access request accepted by the bus access arbitration circuit 7 stops to output the access request signal RQ after the completion of the access to the bus BUSS, that is, the completion of the access to the bus slave 5 or 6. This bus master outputs the access request signal RQ again in order to newly access the bus slave 5 or 6. On the other hand, the bus master having the bus access request which is not accepted by the bus access arbitration circuit 7 outputs the access request signal RQ continuously.

Next, description will be given of operations of the semiconductor circuit in a case where the interruption controller 8 outputs the preferential processing request signal PPR. The interruption controller 8 receives at least one of the interruption request signals INT0 to INT7, and then notifies the CPU 1 to execute interruption processing in accordance with the received interruption request signal and outputs the preferential processing request signal PPR to the bus access arbitration circuit 7. The bus access arbitration circuit 7 receives the preferential processing request signal PPR and, thereafter, accepts the request to access the bus BUSS from the CPU 1 preferentially rather than the requests to access the bus BUSS from the remaining bus masters 2 to 4. It is assumed herein that the access to the bus, which is executed when the bus access arbitration circuit 7 has received the preferential processing request signal PPR, is completed and the CPU 1 outputs the access request signal RQ in order to execute the interruption processing. Herein, even when the remaining bus masters 2 to 4 also output the access request signals RQ, the bus access arbitration circuit 7 accepts the bus access request from the CPU 1 firstly, and then outputs to the CPU 1 the grant signal GRT indicating the acceptance of the bus access request. Accordingly, the CPU 1 can output the control signal CNTM to execute the interruption processing on the basis of the notification from the interruption controller 8.

At the time when the interruption controller 8 accepts the interruption request, moreover, the access to the bus by the CPU 1 is pending and the CPU 1 outputs the access request signal RQ. Even in this case, when the bus access arbitration circuit 7 receives the preferential processing request signal PPR, the access to the bus by the CPU 1 is executed preferentially. Therefore, the CPU 1 can promptly start to execute subsequent interruption processing.

In the semiconductor circuit according to the first embodiment, as described above, when the interruption controller 8 accepts the interruption request, the bus access arbitration circuit 7 accepts the request to access the bus BUSS from the CPU 1 preferentially rather than the requests to access the bus BUSS from the remaining bus masters 2 to 4. Therefore, the CPU 1 can execute the interruption processing early.

### Second Embodiment

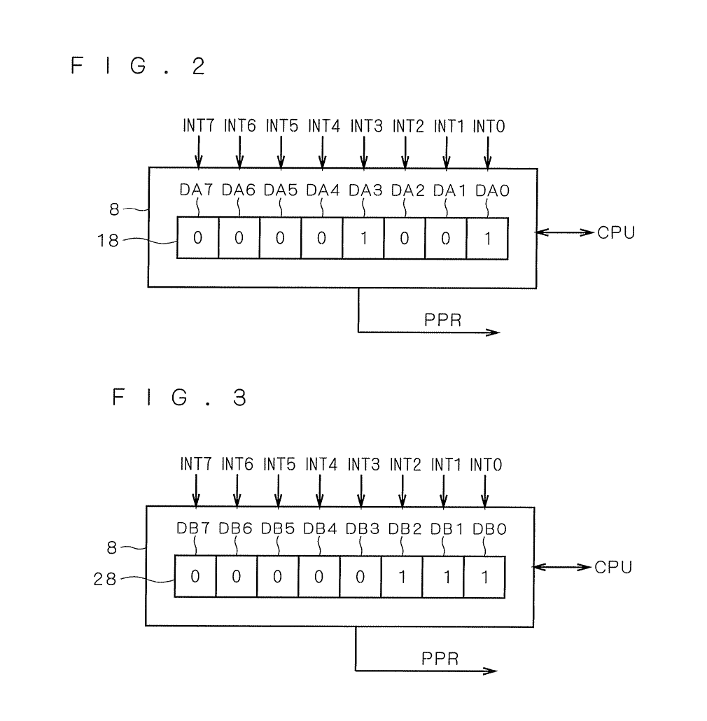

FIG. 2 shows a configuration of an interruption controller 8 of a semiconductor circuit according to a second embodiment of the present invention. The semiconductor circuit according to the second embodiment is different from the semiconductor circuit according to the first embodiment in a point that the interruption controller 8 includes a selection register 18. The interruption controller 8 according to the second embodiment outputs a preferential processing request signal PPR only in a case of accepting a predetermined interruption request of various interruption requests.

The selection register 18 stores therein 8 bits of data DA0 to DA7. The 8 bits of data DA0 to DA7 correspond to eight interruption request signals INT0 to INT7, respectively. The interruption controller 8 outputs the preferential processing request signal PPR only in a case of receiving an interruption request signal corresponding to data, which indicates “1”, of the 8 bits of data DA0 to DA7. In the example shown in FIG. 2, the lowest bit of data DA0 and the fourth bit of data DA3 from the bottom each indicate “1”. In this example, accordingly, the interruption controller 8 outputs the preferential processing request signal PPR only in the case of receiving the interruption request signal INT0 or INT3.

Herein, a CPU 1 can write the 8 bits of data DA0 to DA7 to the selection register 18. Moreover, an external connection terminal may be provided for allowing a user to write the 8 bits of data DA0 to DA7 directly to the selection register 18. Other constituent elements of the semiconductor circuit according to the second embodiment are similar to those of the semiconductor circuit according to the first embodiment; therefore, detailed description thereof will not be given here.

In the semiconductor circuit according to the second embodiment, as described above, the interruption controller 8 outputs the preferential processing request signal PPR only in the case of accepting the predetermined interruption request. Therefore, bus masters 2 to 4 other than the CPU 1 can access a bus without being hindered as much as possible. Further, the CPU 1 can execute predetermined interruption processing early.

In the second embodiment, the selection register 18 is provided for designating the predetermined interruption request for outputting the preferential processing request signal PPR. Therefore, an interruption request to be accepted preferentially can be designated readily when data is written to the selection register 18.

### Third Embodiment

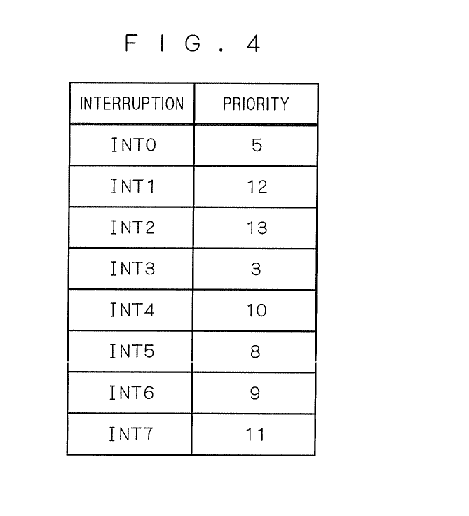

FIG. 3 shows a configuration of an interruption controller 8 of a semiconductor circuit according to a third embodiment of the present invention. The semiconductor circuit according to the third embodiment is different from the semiconductor circuit according to the first embodiment in a point that the interruption controller 8 includes a level designation register 28. The interruption controller 8 according to the third embodiment outputs a preferential processing request signal PPR only in a case of accepting an interruption request having a high priority.

FIG. 4 shows one example of priorities assigned to interruption request signals INT0 to INT7. In the example shown in FIG. 4, numerals “5”, “12”, “13”, “3”, “10”, “8”, “9” and “11” are assigned to the interruption request signals INT0, INT1, INT2, INT3, INT4, INT5, INT6 and INT7, respectively. In this example, a smaller numeral denotes a higher priority. It is assumed in the third embodiment that the priorities shown in FIG. 4 are assigned to the interruption request signals INT0 to INT7.

The level designation register 28 stores therein 8 bits of data DB0 to DB7 each expressing a reference priority in binary. The interruption controller 8 outputs the preferential processing request signal PPR only in a case of accepting an interruption request having a priority higher than the reference priority defined by the level designation register 28. In the example shown in FIG. 3, 8 bits of data DB0 to DB7 indicate “00000111”; therefore, the reference priority becomes “7”. In this example, accordingly, the interruption controller 8 outputs the preferential processing request signal PPR only in a case of receiving the interruption request signal INT0 or INT3 having a priority (“5” as for the interruption request signal INT0, “3” as for the interruption request signal INT3) higher than the reference priority “7”.

Alternatively, the interruption controller 8 may output the preferential processing request signal PPR only in a case of receiving an interruption request signal having a priority which is equal to or more than the reference priority.

Herein, a CPU 1 can write the 8 bits of data DB0 to DB7 to the level designation register 28. Moreover, an external connection terminal may be provided for allowing a user to write the 8 bits of data DB0 to DB7 directly to the level designation register 28. Other constituent elements of the semiconductor circuit according to the third embodiment are similar to those of the semiconductor circuit according to the first embodiment; therefore, detailed description thereof will not be given here.

In the semiconductor circuit according to the third embodiment, as described above, the interruption controller 8 outputs the preferential processing request signal PPR only in the case of accepting the predetermined interruption request, as in the second embodiment. Therefore, bus masters 2 to 4 other than the CPU 1 can access a bus without being hindered as much as possible. Further, the CPU 1 can execute predetermined interruption processing early.

Moreover, the interruption controller 8 according to the third embodiment outputs the preferential processing request signal PPR in the case of accepting the interruption request having the priority higher than the reference priority, but does not output the preferential processing request signal PPR in the case of accepting the interruption request having the priority lower than the reference priority. Therefore, the CPU 1 can preferentially execute only interruption processing which must be executed at an early stage absolutely.

### Fourth Embodiment

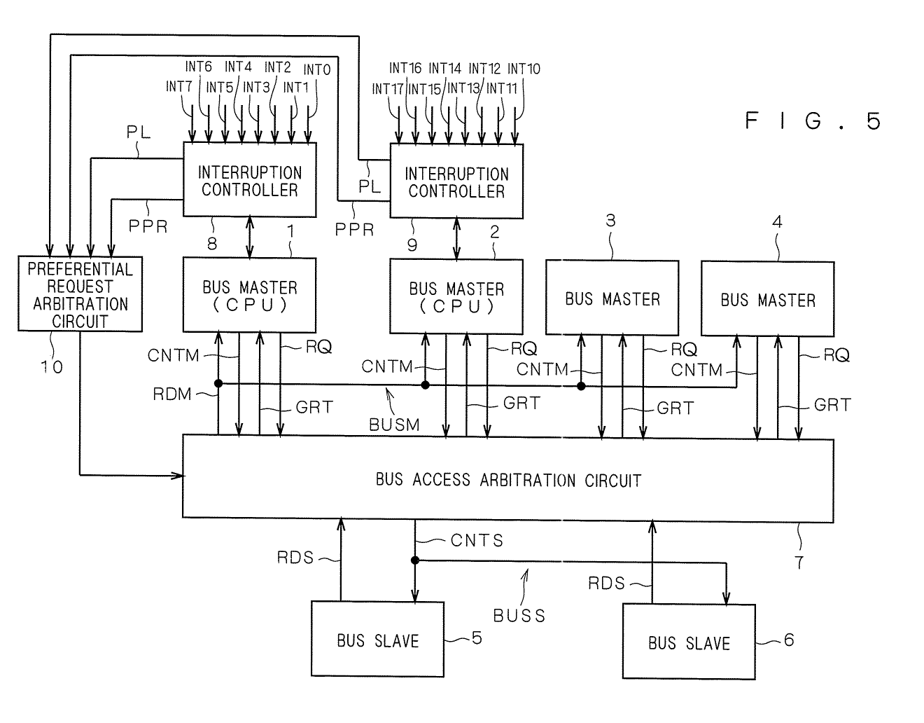

FIG. 5 is a block diagram showing a configuration of a semiconductor circuit according to a fourth embodiment of the present invention. The semiconductor circuit according to the fourth embodiment is different from the semiconductor circuit according to the first embodiment basically in points that a bus master 2 is also a CPU, and an interruption controller 9 and a preferential request arbitration circuit 10 are further provided. Hereinafter, the bus master 2 is referred to as “the CPU 2” in some cases. In the first embodiment, the description has been given of the preferential execution of the interruption processing in the case where one of the bus masters 1 to 4 is a CPU. In the fourth embodiment, on the other hand, description will be given of preferential execution of interruption processing in a case where some of bus masters 1 to 4 are CPUs.

An interruption controller 8 according to the fourth embodiment receives at least one of interruption request signals INT0 to INT7, and then outputs a preferential processing request signal PPR to the preferential request arbitration circuit 10 and outputs a priority notification signal PL to the preferential request arbitration circuit 10. The priority notification signal PL indicates a priority of the interruption request signal selected by the interruption controller 8. It is assumed herein that the foregoing priorities shown in FIG. 4 are assigned previously to the interruption request signals INT0 to INT7. The interruption controller 8 receives the interruption request signals INT0 to INT3 simultaneously, and then selects the interruption request signal INT3 to notify the CPU 1 to execute interruption processing corresponding to the interruption request signal INT3. Further, the interruption controller 8 outputs the priority notification signal PL indicating the priority “3” of the interruption request signal INT3.

On the other hand, the interruption controller 9 accepts an interruption request from the CPU 2, and then notifies the CPU 2 to execute interruption processing in accordance with the interruption request. The interruption controller 9 receives plural interruption request signals INT10 to INT17 each indicating an interruption request. The interruption request signals INT10 to INT17 correspond to various kinds of interruption processing, and are outputted from bus slaves 5 and 6 as well as other peripheral circuits (not shown). Herein, priorities are assigned to the interruption request signals INT10 to INT17. The interruption controller 9 receives some of the interruption request signals INT10 to INT17 simultaneously, and then selects the interruption request signal having the highest priority from among the received interruption request signals and notifies the CPU 2 to execute interruption processing corresponding to the selected interruption request signal. Thus, the CPU 2 executes the interruption processing on the basis of the notification from the interruption controller 9. It is to be noted that, in a case of receiving only one of the interruption request signals INT10 to INT17, the interruption controller 9 selects the received interruption request signal.

Further, the interruption controller 9 receives at least one of the interruption request signals INT10 to INT17, and then outputs to the preferential request arbitration circuit 10 a priority notification signal PL, and a preferential processing request signal PPR for requesting preferential acceptance of a request to access a bus BUSS from the CPU 2 rather than requests to access the bus BUSS from the remaining bus masters 1, 3 and 4. The priority notification signal PL indicates the priority of the interruption request signal selected by the interruption controller 9.

After completion of the interruption processing, the CPUs 1 and 2 notify the interruption controllers 8 and 9 of this completion, respectively. Then, each of the interruption controllers 8 and 9 stops to output the preferential processing request signal PPR.

The preferential request arbitration circuit 10 receives plural preferential processing request signals PPR simultaneously, and then determines a CPU, which has a bus access request to be accepted preferentially, of the CPUs 1 and 2 corresponding to the interruption controllers 8 and 9 which have outputted the preferential processing request signals PPR and sends information about the determined CPU to the bus access arbitration circuit 7. Specifically, the preferential request arbitration circuit 10 determines, as the CPU having the bus access request to be accepted preferentially, a CPU corresponding to an interruption controller, which has outputted the priority notification signal PL having a higher priority, of the interruption controllers 8 and 9. Thus, the bus access arbitration circuit 7 accepts the bus access request from the CPU determined by the preferential request arbitration circuit 10 preferentially rather than the bus access requests from the bus masters other than the determined CPU, as in the first embodiment.

Alternatively, three of the bus masters 1 to 4 may be CPUs. In a case of receiving preferential processing request signals PPR from the three CPUs simultaneously, the preferential request arbitration circuit 10 determines, as the CPU having the bus access request to be accepted preferentially, the CPU corresponding to the interruption controller, which outputs the priority notification signal PL having the highest priority, of the interruption controllers which have outputted the preferential processing request signals PPR.

In a case of receiving only one preferential processing request signal PPR, moreover, the preferential request arbitration circuit 10 determines, as the CPU having the bus access request to be accepted preferentially, the CPU corresponding to the interruption controller which has outputted the preferential processing request signal PPR.

If the priority notification signal PL outputted from the interruption controller 8 is equal in priority to the priority notification signal PL outputted from the interruption controller 9, the preferential request arbitration circuit 10 may determine either the CPU 1 or 2 as the CPU having the bus access request to be accepted preferentially. In this embodiment, the CPU 1 is determined as the CPU having the bus access request to be accepted preferentially. Other constituent elements of the semiconductor circuit according to the fourth embodiment are similar to those of the semiconductor circuit according to the first embodiment; therefore, detailed description thereof will not be given here.

In the semiconductor circuit according to the fourth embodiment, as described above, the CPU having the request to access the bus BUSS to be accepted preferentially is determined from among the plural CPUs included in the bus masters 1 to 4, and the bus access request from the determined CPU is accepted preferentially rather than the bus access requests from the remaining bus masters. Therefore, the determined CPU can execute the interruption processing early.

In addition, the preferential request arbitration circuit 10 determines the CPU having the bus access request to be accepted preferentially, on the basis of the priorities assigned to the interruption requests. Therefore, interruption processing which must be executed early can be executed preferentially.

Also in the semiconductor circuit according to the fourth embodiment, each of the interruption controllers 8 and 9 may output the preferential processing request signal PPR only in a case of accepting a predetermined interruption request of various interruption requests, as in the second and third embodiments.

### Fifth Embodiment

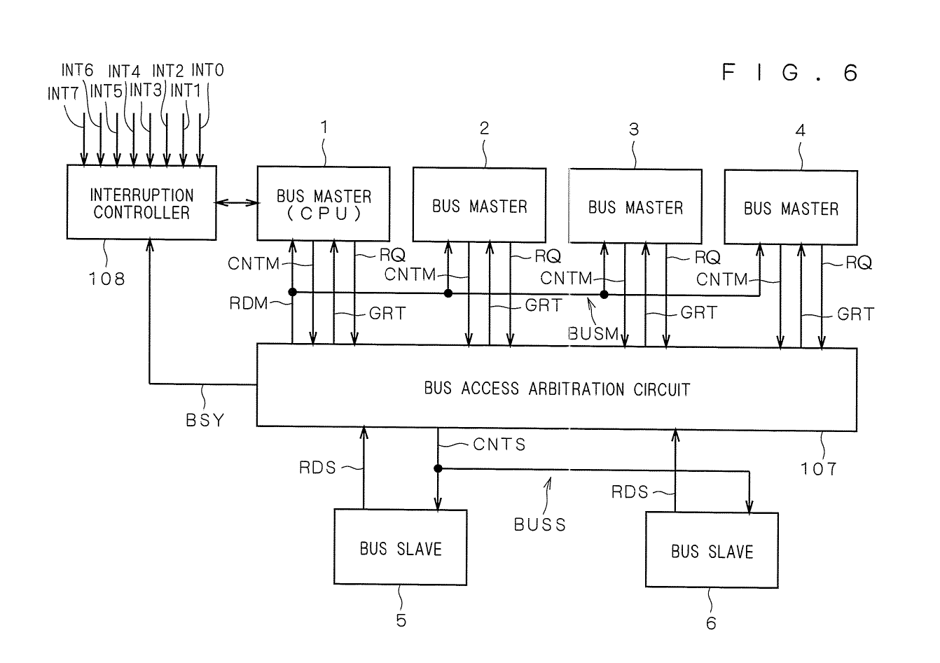

FIG. 6 is a block diagram showing a configuration of a semiconductor circuit according to a fifth embodiment of the present invention. The semiconductor circuit according to the fifth embodiment is different from the semiconductor circuit according to the first embodiment in a point that a bus access arbitration circuit 107 and an interruption controller 108 are provided in place of the bus access arbitration circuit 7 and the interruption controller 8.

Basically, the bus access arbitration circuit 107 performs operations similar to those of the bus access arbitration circuit 7 according to the first embodiment. However, the bus access arbitration circuit 107 is different from the bus access arbitration circuit 7 in the following points. That is, the bus access arbitration circuit 107 outputs a busy signal BSY during a period that bus accesses from bus masters other than a CPU 1 are concentrated. Further, the bus access arbitration circuit 107 does not receive a preferential processing request signal PPR and does not accept a bus access request from the CPU 1 preferentially. The bus access arbitration circuit 107 determines whether the bus accesses from the bus masters other than the CPU 1 are concentrated. During the period that the bus accesses from the bus masters other than the CPU 1 are concentrated, the bus access arbitration circuit 107 outputs the busy signal BSY to the interruption controller 108. For example, in a case of receiving access request signals RQ exceeding a predetermined number from the bus masters other than the CPU 1, the bus access arbitration circuit 107 determines that the bus accesses from the bus masters other than the CPU 1 are concentrated. Then, the bus access arbitration circuit 107 outputs the busy signal BSY to the interruption controller 108 during the reception of the access request signals RQ exceeding the predetermined number. In this embodiment, in a case of receiving two or more access request signals RQ from the bus masters other than the CPU 1, the bus access arbitration circuit 107 determines that the bus accesses from the bus masters other than the CPU 1 are concentrated.

The interruption controller 108 accepts an interruption request, and then notifies the CPU 1 to execute interruption processing in accordance with the interruption request. The interruption controller 108 receives interruption request signals INT0 to INT7, as in the first embodiment. The interruption controller 108 receives some of the interruption request signals INT0 to INT7 simultaneously, and then selects an interruption control signal having a highest priority from among the received interruption request signals and notifies the CPU 1 to execute interruption processing corresponding to the selected interruption request signal. Thus, the CPU 1 executes the interruption processing on the basis of the notification from the interruption controller 108. It is to be noted that, in a case of receiving only one of the interruption request signals INT0 to INT7, the interruption controller 108 selects the received interruption request signal.

During the reception of the busy signal BSY from the bus access arbitration circuit 107, the interruption controller 108 does not notify the CPU 1 to execute interruption processing. Accordingly, the CPU 1 executes no interruption processing during the period that the interruption controller 108 receives the busy signal BSY even when the interruption controller 108 accepts an interruption request. Other constituent elements of the semiconductor circuit according to the fifth embodiment are similar to those of the semiconductor circuit according to the first embodiment; therefore, detailed description thereof will not be given here.

In the semiconductor circuit according to the fifth embodiment, as described above, the interruption controller 108 does not notify the CPU 1 to execute interruption processing during the reception of the busy signal BSY. Therefore, if the bus accesses from the bus masters other than the CPU 1 are concentrated, the CPU 1 issues no request to access a bus BUSS based on interruption processing. Accordingly, the bus masters 2 to 4 can access the bus without being hindered by the interruption processing of the CPU 1.

According to the fifth embodiment, in the case of receiving the access request signals RQ exceeding the predetermined number from the bus masters other than the CPU 1, the bus access arbitration circuit 107 determines that the bus accesses from the bus masters other than the CPU 1 are concentrated. However, such concentration of the bus access requests may be determined by another method. For example, the plural bus masters are typically different from each other in an amount of data to be processed. Further, as an amount of data to be processed is larger, access to a bus is executed frequently. Therefore, if a bus master having a relatively large amount of data to be processed outputs the access request signal RQ, it may be determined that the accesses to the bus are concentrated.

### Sixth Embodiment

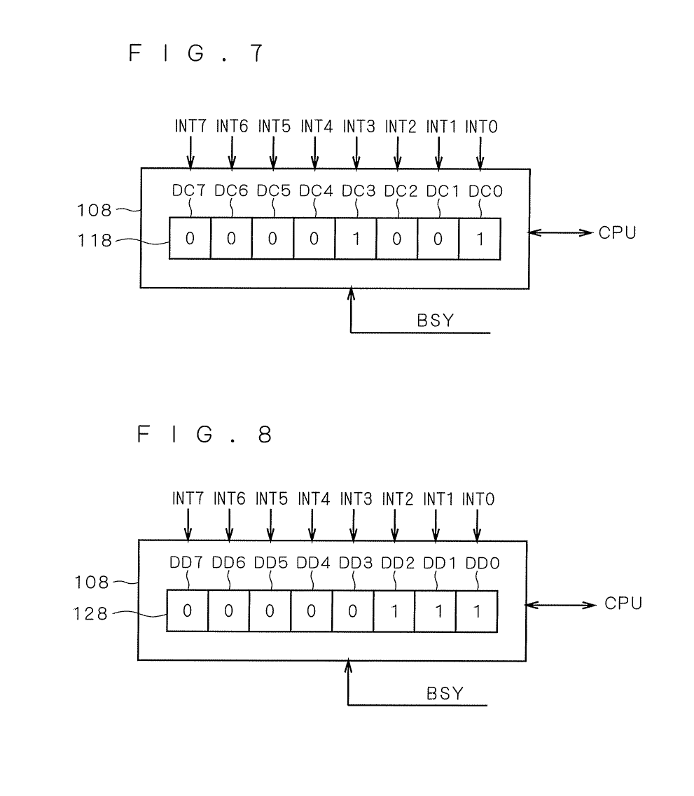

FIG. 7 shows a configuration of an interruption controller 108 of a semiconductor circuit according to a sixth embodiment of the present invention. The semiconductor circuit according to the sixth embodiment is different from the semiconductor circuit according to the fifth embodiment in a point that the interruption controller 108 includes a selection register 118. The interruption controller 108 according to the sixth embodiment does not notify a CPU 1 to execute interruption processing during reception of a busy signal BSY only in a case of accepting a predetermined interruption request of various interruption requests.

The selection register 118 stores therein 8 bits of data DC0 to DC7. The 8 bits of data DC0 to DC7 correspond to eight interruption request signals INT0 to INT7, respectively. The interruption controller 108 does not notify the CPU 1 to execute the interruption processing during the reception of the busy signal BSY only in a case of receiving an interruption request signal corresponding to data, which indicates “1”, of the 8 bits of data DC0 to DC7. In the example shown in FIG. 7, the lowest bit of data DC0 and the fourth bit of data DC3 from the bottom each indicate “1”. In this example, accordingly, the interruption controller 108 does not notify the CPU 1 to execute the interruption processing during the reception of the busy signal BSY only in a case of receiving the interruption request signal INT0 or INT3. In other words, the interruption controller 108 notifies the CPU 1 to execute the interruption processing during the reception of the busy signal BSY only in a case of receiving the interruption request signal INT1, INT2, INT4, INT5, INT6 or INT7.

Herein, the CPU 1 can write the 8 bits of data DC0 to DC7 to the selection register 118. Moreover, an external connection terminal may be provided for allowing a user to write the 8 bits of data DC0 to DC7 directly to the selection register 118. Other constituent elements of the semiconductor circuit according to the sixth embodiment are similar to those of the semiconductor circuit according to the fifth embodiment; therefore, detailed description thereof will not be given here.

In the semiconductor circuit according to the sixth embodiment, as described above, the interruption controller 108 does not notify the CPU 1 to execute the interruption processing during the reception of the busy signal BSY only in the case of accepting the predetermined interruption request. Therefore, bus masters 2 to 4 other than the CPU 1 can access a bus without being hindered by the interruption processing of the CPU 1. Further, an allowance for execution of the interruption processing by the CPU 1 can be ensured to a certain degree.

In the sixth embodiment, moreover, the selection register 118 is provided for selecting an interruption request for inhibiting the CPU 1 from executing the interruption processing during output of the busy signal BSY, from among the various interruption requests. Therefore, an interruption request to be masked can be designated readily when data is written to the selection register 118.

### Seventh Embodiment

FIG. 8 shows a configuration of an interruption controller 108 of a semiconductor circuit according to a seventh embodiment of the present invention. The semiconductor circuit according to the seventh embodiment is different from the semiconductor circuit according to the fifth embodiment in a point that the interruption controller 108 includes a level designation register 128. The interruption controller 108 according to the seventh embodiment does not notify a CPU 1 to execute interruption processing during reception of a busy signal BSY only in a case of accepting an interruption request having a low priority.

The level designation register 128 stores therein 8 bits of data DD0 to DD7 each expressing a mask reference priority in binary. The interruption controller 108 does not notify the CPU 1 to execute the interruption processing during the reception of the busy signal BSY only in a case of accepting an interruption request having a priority lower than the mask reference priority defined by the level designation register 128. In the example shown in FIG. 8, 8 bits of data DD0 to DD7 indicate “00000111”; therefore, the mask reference priority becomes “7”. Accordingly, if the priorities shown in FIG. 4 are assigned to interruption request signals INT0 to INT7, the interruption controller 108 does not notify the CPU 1 to execute the interruption processing during the reception of the busy signal BSY only in a case of receiving the interruption request signal INT1, INT2, INT4, INT5, INT6 or INT7 having a priority lower than the mask reference priority “7”. In other words, the interruption controller 108 notifies the CPU 1 to execute the interruption processing during the reception of the busy signal BSY only in a case of receiving the interruption request signal INT0 or INT3.

Alternatively, the interruption controller 108 may not notify the CPU 1 to execute the interruption processing only in a case of receiving an interruption request signal having a priority which is equal to or less than the mask reference priority.

Herein, the CPU 1 can write the 8 bits of data DD0 to DD7 to the level designation register 128. Moreover, an external connection terminal may be provided for allowing a user to write the 8 bits of data DD0 to DD7 directly to the level designation register 128. Other constituent elements of the semiconductor circuit according to the seventh embodiment are similar to those of the semiconductor circuit according to the fifth embodiment; therefore, detailed description thereof will not be given here.

In the semiconductor circuit according to the seventh embodiment, as described above, the interruption controller 108 does not notify the CPU 1 to execute the interruption processing during the reception of the busy signal BSY only in the case of accepting the predetermined interruption request, as in the semiconductor circuit according to the sixth embodiment. Therefore, bus masters other than the CPU 1 can access a bus without being hindered by the interruption processing of the CPU 1. Further, an allowance for execution of the interruption processing by the CPU 1 can be ensured to a certain degree.

In addition, the interruption controller 108 according to the seventh embodiment does not notify the CPU 1 to execute the interruption processing in a case of accepting an interruption request having a priority lower than the mask reference priority. On the other hand, the interruption controller 108 notifies the CPU 1 to execute the interruption processing in a case of accepting an interruption request having a priority higher than the mask reference priority. Therefore, the bus masters other than the CPU 1 can access the bus without being hindered by the interruption processing of the CPU 1. Further, the CPU 1 can execute interruption processing which must be executed at an early stage absolutely.

While the invention has been shown and described in detail, the foregoing description is in all aspects illustrative and not restrictive. It is therefore understood that numerous modifications and variations can be devised without departing from the scope of the invention.

What is claimed is:

1. A semiconductor circuit comprising:
plural bus masters one of which is a CPU executing interruption processing;
a bus access arbitration circuit which arbitrates bus access requests among said plural bus masters; and
an interruption controller which notifies said CPU to execute the interruption processing, wherein
said interruption controller accepts an interruption request, and then notifies said CPU to execute the interruption processing and outputs, to said bus access arbitration circuit, a preferential processing request signal for requesting preferential acceptance of the bus access request from said CPU, and
said bus access arbitration circuit receives said preferential processing request signal, and then accepts the bus access request from said CPU preferentially rather than the bus access requests from said plural bus masters other than said CPU.

2. The semiconductor circuit according to claim 1, wherein
said interruption controller accepts various interruption requests, and
said interruption controller outputs said preferential processing request signal only in a case of accepting a predetermined interruption request of said various interruption requests.

3. The semiconductor circuit according to claim 2, wherein
said interruption controller includes a selection register which designates said predetermined interruption request.

4. The semiconductor circuit according to claim 2, wherein
each of said various interruption requests has a unique priority assigned thereto,
said interruption controller includes a level designation register which designates a reference priority, and
said interruption controller outputs said preferential processing request signal in a case of accepting an interruption request, which has a priority higher than said reference priority designated by said level designation register, of said various interruption requests, and does not output said preferential processing request signal in a case of accepting an interruption request, which has a priority lower than said reference priority, of said various interruption requests.

5. A semiconductor circuit comprising:
plural bus masters some of which are CPUs;
a bus access arbitration circuit which arbitrates bus access requests among said plural bus masters;
plural interruption controllers which are provided for said plural CPUs in one to one correspondence and each of which notifies the relevant CPU to execute interruption processing; and
a preferential request arbitration circuit, wherein
each of said plural interruption controllers accepts an interruption request from the relevant CPU, and then notifies the relevant CPU to execute the interruption processing and outputs, to said preferential request arbitration circuit, a preferential processing request signal for requesting preferential acceptance of the bus access request from the relevant CPU,
said preferential request arbitration circuit receives the plural preferential processing request signals simultaneously, and then determines a CPU, which has the bus access request to be accepted preferentially, of the CPUs corresponding to the interruption controllers which have outputted the preferential processing request signals, and
said bus access arbitration circuit accepts the bus access request from the CPU determined by said preferential request arbitration circuit preferentially rather than the bus access requests from said plural bus masters other than the determined CPU.

6. The semiconductor circuit according to claim 5, wherein
each of said plural interruption controllers accepts various interruption requests each having a unique priority assigned thereto,
each of said plural interruption controllers outputs, to said preferential request arbitration circuit, said preferential processing request signal, and a priority notification signal indicating a priority assigned to a interruption request, which corresponds to the interruption processing to be executed by the relevant CPU, of said various interruption requests, and
said preferential request arbitration circuit receives the plural preferential processing request signals simultaneously, and then determines, as the CPU having the bus access request to be accepted preferentially, the CPU corresponding to an interruption controller, which has outputted said priority notification signal having the highest priority, of said interruption controllers which have outputted the preferential processing request signals.

7. A semiconductor circuit comprising:
plural bus masters one of which is a CPU executing interruption processing;
a bus access arbitration circuit which arbitrates bus access requests among said plural bus masters; and
an interruption controller which accepts an interruption request to notify said CPU to execute the interruption processing, wherein
said bus access arbitration circuit determines whether bus accesses from said plural bus masters other than said CPU are concentrated, and then outputs a busy signal to said interruption controller during a period that the bus accesses are concentrated, and
said interruption controller does not notify said CPU to execute the interruption processing during reception of said busy signal.

8. The semiconductor circuit according to claim 7, wherein
said interruption controller accepts various interruption requests,
said interruption controller does not notify said CPU to execute the interruption processing during the reception of said busy signal only in a case of accepting a predetermined interruption request of said various interruption requests.

9. The semiconductor circuit according to claim 8, wherein
said interruption controller includes a selection register which designates said predetermined interruption request.

10. The semiconductor circuit according to claim 8, wherein
each of said various interruption requests has a unique priority assigned thereto,
said interruption controller includes a level designation register which designates a reference priority, and
said interruption controller does not notify said CPU to execute the interruption processing during the reception of said busy signal in a case of accepting an interruption request, which has a priority lower than said reference priority designated by said level designation register, of said various interruption requests, and notifies said CPU to execute the interruption processing during the reception of said busy signal in a case of accepting an interruption request, which has a priority higher than said reference priority, of said various interruption requests.
